(19) United States
(12) Patent Application Publication
(10) Pub. No.: US 2004/0137953 A1
(43) Pub. Date: Jul. 15, 2004

(54) Wireless signal transmitting and receiving system

(76) Inventors: Paul Tzeng, Taoyuan (TW); Alpha Wu, Taipei (TW)

Correspondence Address: BIRCH STEWART KOLASCH & BIRCH, PO BOX 747, FALLS CHURCH, VA, 22040-0747, US

(21) Appl. No.: 10/428,945

(22) Filed: May 5, 2003

(30) Foreign Application Priority Data
Jan. 10, 2003 (TW) 092100529

(51) Int. Cl. H04M 1/00

(52) U.S. Cl. 455/566; 455/550.1

(57) ABSTRACT

A wireless signal transmitting and receiving system adopted for use on display devices for receiving wireless signals in an omnidirectional fashion consists of an transmission end for generating transmission signals and a band-type receiving area located on one end of the exterior of a display device for receiving transmission signals and displaying them on the display device. The system provided by the invention can reduce the signal interruption problem caused by objects moving between the transmission end and the receiving area.

### BACKGROUND OF THE INVENTION

1. Field of Invention

The invention relates to a wireless signal transmitting and receiving system, and particularly to a wireless signal transmitting and receiving system that transmits digital signals through an optical approach.

2. Related Art

High definition TVs (HDTVs) are one kind of advanced TV (ATV) that aims at providing picture quality similar to 35 mm film and sound effects like CDs. The U.S. Federal Communications Commission (FCC) has dedicated frequency channels for ATVs (including HDTV). At present, U.S. public TV and a number of commercial TVs have adopted this technology. HDTV is usually used interchangeably with digital TV. However, digital TV only transmits through digital signals, while HDTV transmits through both analog and digital signals.

Conventional TVs or HDTVs have a plurality of connectors to connect peripheral video and audio devices such as VCRs, video cameras or Set-up boxes. On the conventional TV, the number of these connectors is mostly fixed, and has become a standard for general TVs. However, for HDTVs that are still in the development stage, there is no such a standard.

Plasma TVs or liquid crystal TVs are the typical thin frame TV at present. Compared with the conventional TV, their size is greatly reduced. They also provide an improved aesthetic visual appeal. This type of TV is mostly hung on the wall for displaying to showcase their simplicity. However, when connecting to a plurality of peripheral devices, the wiring is messy and becomes an eyesore. To remedy this problem, a wireless transmission and receiving device for HDTV has been developed. The signals of all video and audio peripheral devices may be transmitted and received through this device to the TV.

However, the present wireless transmitting and receiving devices mostly use point-to-point communication. When encountering spatial and geographical constraints, or movements of human being between the transmitting end and the receiving end, signal transmission is disrupted, and viewing at the user end is affected.

### SUMMARY OF THE INVENTION

The primary object of the invention is to provide a wireless signal transmitting and receiving system to increase the scope of the receiving area and overcome the signal interruption problem that occurs with point-to-point transmission.

In order to achieve the foregoing object, the invention provides a wireless signal transmitting and receiving system adopted for use on display devices that can receive wireless signals in an omnidirectional fashion. The system includes an transmission end and a receiving area. The transmission end can generate a transmission signal. The receiving area is located outside a display device to receive the transmission signal and display it on the display device. The receiving area is made from silicon fiber.

The foregoing, as well as additional objects, features and advantages of the invention will be more readily apparent from the following detailed description, which proceeds with reference to the accompanying drawings.

### BRIEF DESCRIPTION OF THE DRAWINGS

The present invention will become more fully understood from the detailed description given hereinbelow illustration only, and thus are not limitative of the present invention, and wherein:

FIG. 1 is a structural diagram for the wireless signal transmitting and receiving system of the invention.

FIG. 2 is a schematic view for signal transmitting and receiving of the wireless signal transmitting and receiving system of the invention.

### DESCRIPTION OF THE PREFERRED EMBODIMENT

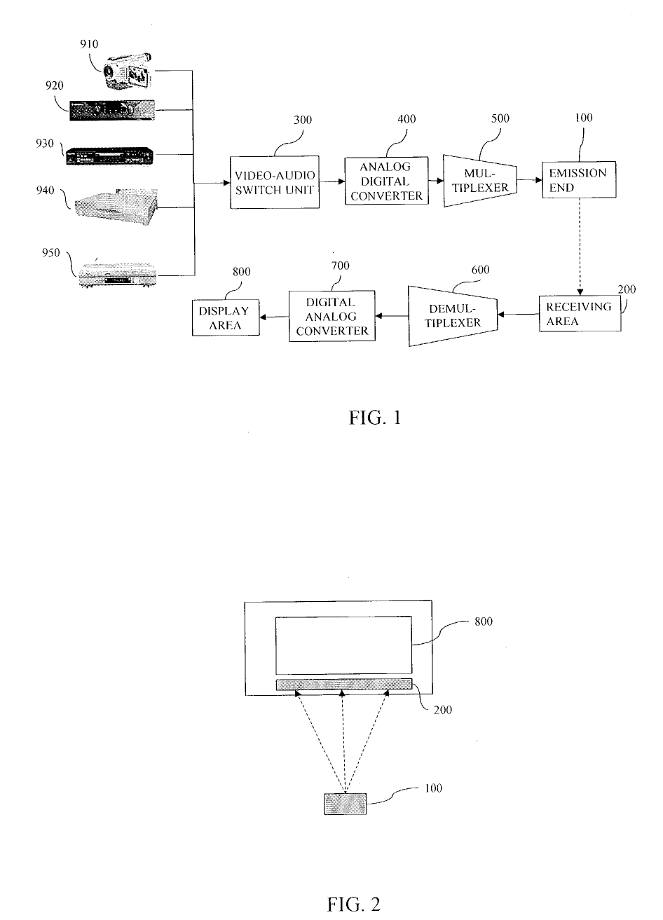

Refer to FIG. 1 for the system architecture of the wireless signal transmitting and receiving system of the invention. It includes an transmission end 100 and a receiving area 200 for transmitting signals through an optical approach. The transmission end 100 is located on a signal transmission device. The signal transmission device can connect a plurality of video and audio peripheral devices such as digital video cameras 910, wired signal set-up boxes 920, DVD players 930, wireless signal connection boxes 940 or VCRs 950. The output of these peripheral devices is linked to a video-audio switch unit 300. The output of the video-audio switch unit 300 is linked to an analog digital signal converter 400, which converts analog signals to digital signals. The converted digital signals are input to a multiplexer 500, and finally are transmitted through the transmission end 100. Thus the signals being transmitted are in a digital format, and are carried by laser light for transmission.

The receiving area 200 is installed on one end of the exterior of a display device and has a plurality of terminals to receive the digital signals transmitted from the transmission end 100. After having received the digital signals, the digital signals are transmitted to a demultiplexer 600, which has an output linking to a digital analog signal converter 700 for converting the digital signals to analog signals, and displaying them on a display area 800 of the display device. The receiving area 200 is made from silicon fiber. The receiving area 200, multiplexer 600 and digital analog signal converter 700 shown in FIG. 1 are installed on the display device.

Refer to FIG. 2 for the schematic view of signal transmitting and receiving according to the invention. The receiving area 200 is located on one end of the exterior of the display device 800 to receive digital signals transmitted from the transmission end 100. The receiving area 200 is a band type receiving area. The receiving area 200 shown in FIG. 2 is located on a lower end of the frame of the display device 800. This only serves as an example of the embodiment, and the location of the receiving area 200 is not limited to this. It may be installed on other locations of the display device 800 as required. The arrow direction shown by broken lines in the picture indicates the direction of signal transmission. As shown in the drawing, the receiving area 200 can receive signals in an omnidirectional fashion. When signals are interrupted due to the movement of objects between the transmission end 100 and the receiving area 200, the digital signals can still be received by the receiving area 200 from other directions. Thus the system provided by the invention can resolve the signal interruption problem caused by object interference occurring with point-to-point signal transmission.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A wireless signal transmission and receiving system adopted for use on a display device for receiving wireless signals omnidirectionally, comprising:
a transmitting end for generating a transmission signal; and
a receiving area located on one end of the exterior of the display device and having a plurality of terminals to receive the transmission signal and display on the display device.

2. The system of claim 1, wherein the transmission signal is a digital signal.

3. The system of claim 1, wherein the receiving area is made from a silicon fiber.

4. A wireless signal transmission and receiving system adopted for use on a display device for receiving wireless signals omnidirectionally comprising an transmission end for generating a transmission signal and a receiving area located on the exterior of the display device for receiving the transmission signal and displaying on the display device, is characterized in that
the receiving area is band type area and made from a silicon fiber for receiving and transmitting the signal generated by the transmission end.
